(19) United States
(12) Patent Application Publication
(10) Pub. No.: US 2008/0273622 A1
(43) Pub. Date: Nov. 6, 2008

(54) Channel optimization for adaptive information rate schemes

(75) Inventors: Petri Bergholm, Nummela (FI); Jarmo Makinen, Espoo (FI); Leonid Bogod, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/878,922

(22) Filed: Jul. 27, 2007

(30) Foreign Application Priority Data
May 2, 2007 (EP) 07008873.7

(51) Int. Cl. H04B 15/00

(52) U.S. Cl. 375/285

(57) ABSTRACT

A method, apparatus, and computer program product is described, wherein an information rate or bandwidth of a transmission signal is controlled in response to a channel condition, and qualities of channels are measured over a transmission bandwidth available for transmission of said transmission signal. A carrier frequency for said transmission signal is selected based on the measured channel qualities.

### FIELD OF THE INVENTION

The present invention relates to a method, apparatus, and computer program product for optimizing received signal quality in systems deploying adaptive information rate schemes.

### BACKGROUND OF THE INVENTION

By adapting symbol rate, modulation, coding, constellation size, power level, etc. to time-varying channels, average data rate can be optimized while maintaining an acceptable bit error rate (BER). As application requirements become more complex, there is a need to take into account higher layer metrics. For instance, adaptive techniques that support different types of traffic with different quality of service (QoS) requirements have been developed.

More specifically, radio link systems that change the symbol rate when adapting to the prevailing propagation conditions have been proposed. Adaptive rate systems deploy adaptive coding and modulation methods in conjunction with the adaptive symbol rate methods. As an example, system capacity in a radio link system with the adaptive symbol rate scheme can be adapted by changing the symbol rate. The modulation method may remain the same, although the symbol rate is changed. The coding scheme can alter over the change. Keeping the modulation method fixed, the transmitted power before and after the change remains at the same level.

However, when high capacity is used, the maximum allowed frequency bandwidth is occupied. Bad weather conditions or strong interference signals may degrade transmission conditions and may thus require decreasing link throughput by decreasing the transmitting symbol rate. In this case, a smaller bandwidth is needed for transmission.

### SUMMARY

It is therefore an object of the present invention to provide a method and apparatus, by means of which signal quality can be optimized in adaptive information rate systems.

This object is achieved by a method comprising:

controlling an information rate or bandwidth of a transmission signal in response to a channel condition;

measuring qualities of channels over a transmission bandwidth available for transmission of said transmission signal; and

selecting a carrier frequency for said transmission signal based on the measured channel qualities.

Additionally, the above object is achieved by an apparatus comprising:

a receiving unit for receiving a transmission signal with an information rate or bandwidth controlled in response to a channel condition;

a measuring unit for measuring qualities of channels over a transmission bandwidth available for transmission of said transmission signal; and

a selection unit for selecting a carrier frequency for said transmission signal based on the measured channel qualities.

Moreover, the above object is achieved by a computer program product comprising code means for producing the steps of the above-defined method when run on a computer device.

Accordingly, a favourable carrier frequency or transmission channel can be selected in terms of channel quality (e.g. noise or interference), to thereby optimize signal quality in adaptive information rate systems with changing bandwidth or information or data rate.

By measuring the channel quality (e.g. error vector spectrum, signal-to-noise ratio, signal-to-interference-and-noise ratio, etc.), it is also possible to detect the frequencies that are faded or that are interfered by other radio systems.

In an embodiment, the measuring of qualities of channels may comprise determining a spectrum of error vector samples. More specifically, the determination of the spectrum may comprise calculating a fast Fourier transform of the error vector samples.

The selection of the carrier frequency may be based on a determination of the minimum interference level over the transmission bandwidth. A change to the selected carrier frequency may be commanded to a far-end transmitter of the transmission signal at a predetermined timing.

In another embodiment, the measuring may comprise sweeping an actual carrier frequency from a minimum allowed frequency to a maximum allowed frequency, and measuring a signal-to-interference-and-noise level during the sweeping.

In a further embodiment, the measuring may comprise switching off transmitters at both transmission ends, sweeping at both transmission ends over the transmission bandwidth, and measuring an interference-and-noise level during the sweeping. The selection may then comprise negotiating a transmission channel between both transmission ends based on the measured interference-and-noise level.

In a still further embodiment, at least one of an interference level and a noise level outside a desired bandwidth of said transmission signal can be estimated, e.g., based on another spectrum calculation, wherein a change of the information rate and/or the selected carrier frequency may then be decided based on the interference estimation.

In the above embodiments, the measuring and selection may be performed in response to a change of the information rate or bandwidth.

Further advantageous modifications are defined in the dependent claims.

### BRIEF DESCRIPTION OF THE DRAWINGS

In the following, the present invention will be described in greater detail based on embodiments with reference to the accompanying drawings, in which:

FIG. 1 shows a schematic block diagram of a channel optimization apparatus according to an embodiment;

FIG. 2 shows a flow diagram of a channel optimization procedure according to an embodiment;

FIG. 3 shows a flow diagram of a channel optimization procedure according to another embodiment;

FIG. 4 shows a flow diagram of a channel optimization procedure according to a further embodiment; and

FIG. 5 shows a schematic block diagram of a software-based implementation according to an embodiment.

### DESCRIPTION OF THE PREFERRED EMBODIMENT

Various embodiments will now be described based on a channel optimization procedure for transceiver and receivers of radio link systems in which the information rate (e.g. data rate) or symbol rate is changed when adapting to the prevailing propagation conditions. The embodiments may also be applied to adaptive rate systems that deploy adaptive coding and modulation methods in conjunction with the adaptive symbol rate method.

More specifically, the proposed optimization method and apparatus can be used in selecting an appropriate operating radio frequency (RF) when the system decides to change the system capacity from high level capacity to lower level capacity.

The system capacity in a radio link system with the adaptive symbol rate scheme can be adapted by changing the symbol rate. The modulation method may remain the same, although the symbol rate is changed. The coding scheme can alter over the change. Keeping the modulation method fixed, the transmitted power before and after the change may remain at the same level.

However, it is noted that the present invention can be implemented or used in any transmission system where adaptive information rates can be employed. More specifically, the present invention can be applied in point-to-point or point-to-multipoint radio applications. It may for example be applied in radio systems like e.g. WiMAX (Worldwide Interoperability for Microwave Access) as currently standardized in IEEE802.16 and WiMAX Forum, WCDMA (Wideband Code Division Multiple Access) as standardized in 3GPP, as well as 3GPP E-UTRAN (Enhanced Universal Mobile Telecommunications System (UMTS) Terrestrial Radio Access Network), such as LTE (Long Term Evolution). These radio access technologies (e.g. WLAN, WiMAX, E-UTRAN or 3G LTE) may involve multiple-input multiple-output (MIMO) systems or multi-beam/multi-antenna transmitter or receiver devices (e.g. base station devices, access points or other access devices) capable of receiving signals via different receiving paths and/or channels.

With favourable channel conditions (e.g. due to good weather conditions) a maximum symbol rate can be transmitted and maximum allowed bandwidth can be occupied. In this case, the RF carrier frequency is determined e.g. by a frequency regulatory authority. However, when channel or transmission conditions are becoming worse, the radio link may need to change transmission from higher symbol rate to lower symbol rate. This could be achieved in the following manner:

The starting point is that the radio link is using the whole allocated bandwidth W₀ of a radio channel, e.g. 28 MHz. The initial carrier frequency is F₀ i.e. the center frequency of the channel. The radio receiver measures that the channel quality (e.g. signal-to-noise and/or interference ratio) is degrading and it continues to degrade below a predefined threshold level (e.g. 5 dB) where the change to lower symbol rate can be done. In this case, the transmission requires less bandwidth W₁, e.g., half of the whole allocated bandwidth (i.e. 14 MHz).

According to an embodiment, an optimum carrier frequency which provides the best transmission condition can then be searched. This can be achieved by collecting error vector (EV) samples into a memory and calculating a spectral distribution (frequency domain) thereof, e.g. by calculating a fast Fourier transform (FFT) for the samples. The resolution in the frequency domain depends on the number of samples e.g. in the FFT calculation. The FFT calculation can be done by either software (SW) or hardware (HW), depending on the available resources.

Optionally, before applying FFT, the EV samples can be weighted by the receiver impulse response of the low symbol rate mode.

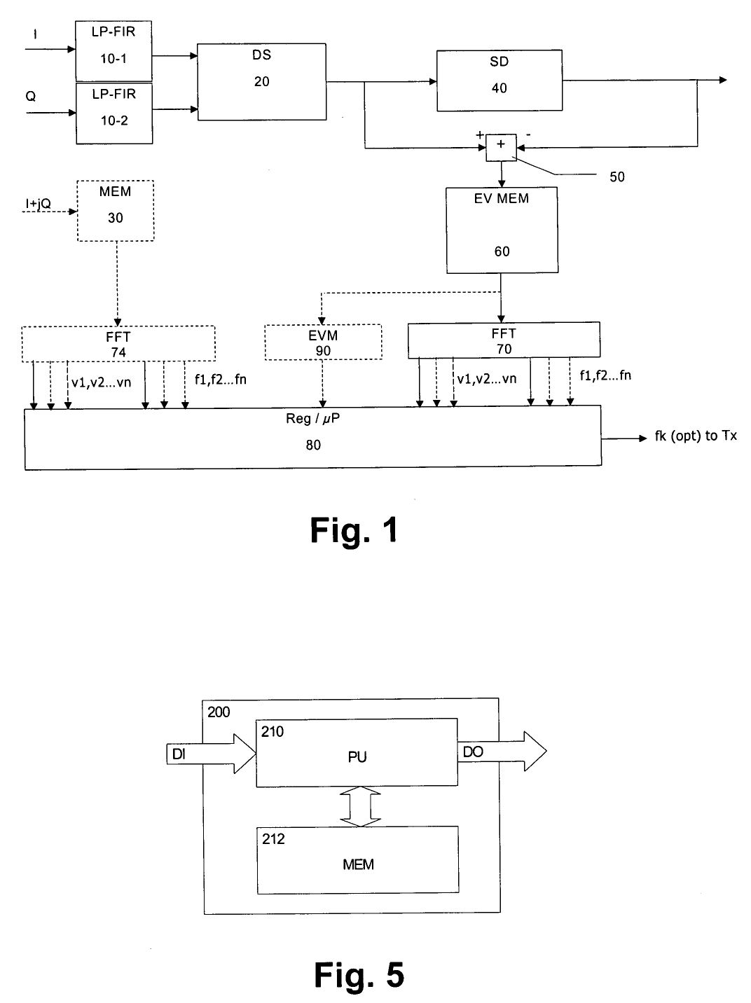

FIG. 1 shows a schematic block diagram of a channel optimization apparatus according to an embodiment, which can be provided in a receiver or transceiver e.g. of a terminal device of a transmission system. In this embodiment, carrier frequency channel optimization is achieved by an error vector spectrum (EVS) analysis. In the exemplary implementation of FIG. 1, the proposed functionality is integrated with an IQ-demodulator.

The in-phase and quadrature components I and Q of an input signal are band-limited by respective low pass (LP) filters 10-1 and 10-2, which may be digital filters, such as finite impulse response (FIR) filters. Then, the filtered components are combined in a down-sampling unit 20 and the combined complex down-sampled output values are supplied to a symbol decision unit 40 to decide on symbol values. The obtained symbol values are subtracted in a subtraction unit 50 from the output values of the down-sampling unit 20 to generate error vector (EV) samples which are stored in an EV memory 60.

An FFT calculator 70 reads the EV samples stored in the EV memory 60 and calculates an FFT of the EV samples to obtain an error vector spectrum which may be specified by respective pairs of frequency values f1, f2, . . . fn and error vector magnitude (EVM) values v1, v2, . . . vn. These value pairs can be supplied to a microprocessor (μP) 80 with register(s), where they are analyzed and an optimum carrier frequency fk(opt) or channel for transmission is selected, as described later.

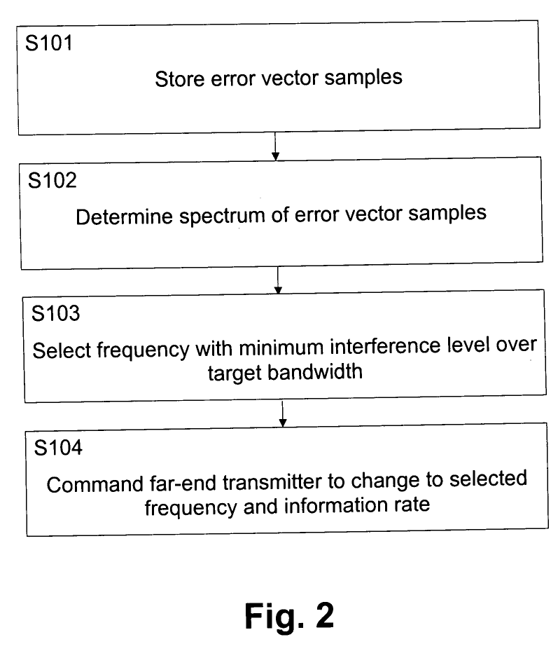

FIG. 2 shows a flow diagram of a channel optimization procedure according to an embodiment which is based on a calculation of the spectrum. To achieve this, an EVM calculator 90 is shown as an alternative or additional block in FIG. 1. It uses the same input data as the FFT calculator 70. Based on the output of the EVM calculator 90, the microprocessor (μP) 80 can calculate the required signal-to-interference-and-noise ratio (SINR) or signal-to-noise ratio (SIR).

In step S101, a radio receiver, receiver module, receiver chip etc. comprising the apparatus of FIG. 1 stores error vector samples in it's memory, e.g., the EV memory 60 of FIG. 1. The spectrum of the error vector samples is measured or determined by the EVM calculator 90 in step S102, which can be achieved by calculating the FFT of the received error vector samples, such as described for example in “Mathematics Handbook for Science and Engineering”, Lennart Rade et al. Sweden, 1995.

Based on the error vector spectrum (or alternatively based on the SNR or SINR), the radio receiver (e.g. the μP 80 of FIG. 1) decides in step S103 at which frequency F₁ the interference level is at minimum over the target band-width and selects the obtained frequency. Target bandwidth is the signal bandwidth of the lower symbol rate W₁.

Finally, in step S104, the radio receiver (e.g. the μP 80 of FIG. 1) commands the far-end radio transmitter to change the RF frequency to F₁ and the information rate (e.g. symbol rate) at the certain time of the time counter. The receiver time counter is synchronised with the far-end transmitter time counter.

The receiver and the far-end transmitter may change the symbol rate and the carrier frequency almost simultaneously. Depending on the frame structure and the buffering arrangements this may or may not introduce a short outage in the link.

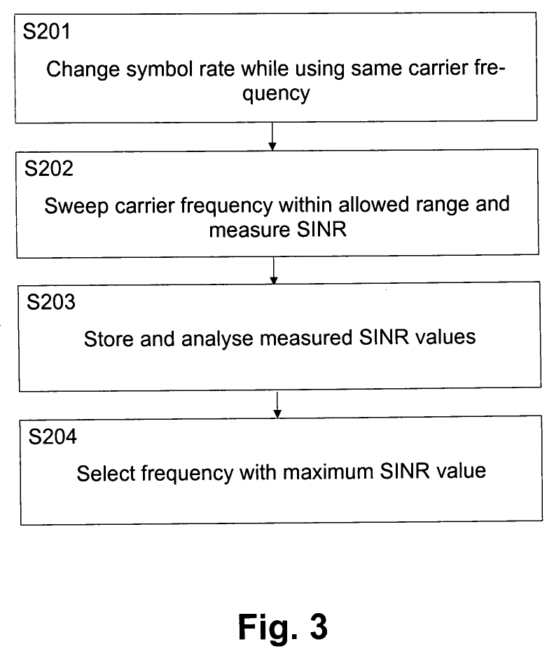

FIG. 3 shows a flow diagram of a channel optimization procedure according to another embodiment. Here, a first option of an SINR method is used for determining the carrier frequency or channel to be selected. More specifically, an SINR measurement with frequency sweeping can be used.

In step S201 of FIG. 3, the transmission or radio link system changes to a lower level symbol rate while still using the same carrier frequency F₀. After the symbol rate change the transmitter starts in step S202 to sweep the carrier frequency from a minimum allowed carrier frequency Fₘᵢₙ to a maximum allowed frequency Fₘₐₓ within the initial bandwidth W₀ with the frequency step dF.

Fₘᵢₙ=F₀−(W₀−W₁)/2,

Fₘₐₓ=F₀+(W₀−W₁)/2 and

dF=W₁,

where

F₀ is the initial carrier frequency for maximum symbol rate,

W₀ is the whole allocation bandwidth for the maximum symbol rate and

W₁ is the new allocation bandwidth for new symbol rate.

To increase accuracy, frequency steps could be decreased to dF=W₁/n, where n may be an integer in the range of e.g. n=1 . . . 10. The new transmission frequency will then be in the middle of an optimum bandwidth W₁=dF*n.

Then, in step S203, the result of SINR values measured or calculated based on the output of the EVM calculator 90 during the frequency sweep is stored, e.g., in the memory 60 of FIG. 1 and analysed, e.g., by the μP 80 of FIG. 1. The maximum SINR value can be used as the new optimal carrier frequency F₁. In this embodiment, blocks 30 to 60 of FIG. 1 can be replaced a measuring or determination unit for obtaining SINR values.

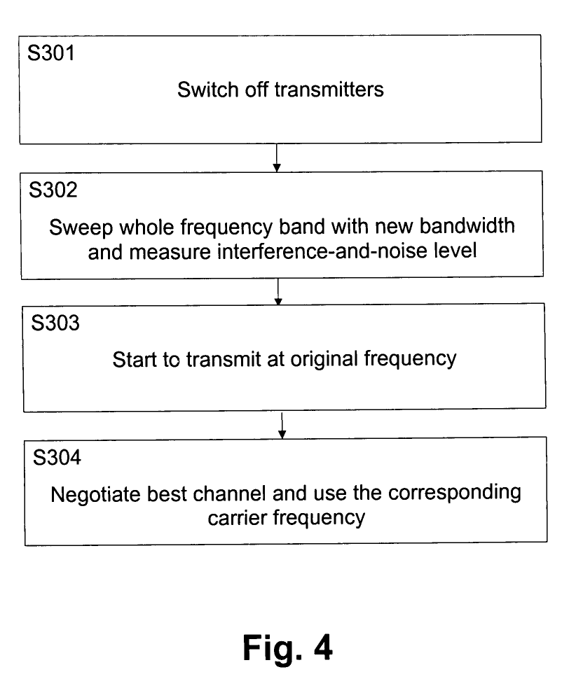

FIG. 4 shows a flow diagram of a channel optimization procedure according to a further embodiment which is directed to a second option of the SINR method. The SINR method is now implemented in the following manner:

In step S301 both ends of the transmission link switch off their transmitters. Then, in step S302, the receivers at both ends sweep the whole frequency band W₀ with the new bandwidth W₁ and measure interference and noise level.

After the sweep, in step S303 both transmitters start to transmit at the original frequency F₀ and to find the connection. Finally, in step S304, the transceivers (e.g. μP 80 of FIG. 1) negotiate the best channel in the SINR sense and move the transmission to those frequencies by using them as carrier frequencies.

All three optimization procedures of FIGS. 2 to 4 could be used alone or in some combination. They may optionally be initiated or started in response to a change of the information rate (e.g. data or symbol rate) or bandwidth of the received transmission signal, which could be detected at or signalled to the receiver or transceiver. In the SINR method option 2 of FIG. 4, the transmission needs to be stopped during the sweep and measurement period. However, if the rule of changing the symbol rate is determined in advance or by a look-up table, the transmission need not be stopped. It is not necessary that the transmitter (part) and the receiver (part) at one transmission end use the same frequency.

When transmission conditions are becoming better, the link will change the transmission mode from lower symbol rate to higher symbol rate. In this case the second method of FIG. 3 is advantageous (while the first method, i.e. the EVS method, can only measure the interference spectrum under the wanted signal and thus it cannot estimate the interference situation in the new higher signal bandwidth).

In this lower-to-higher symbol rate case the determination of the new carrier frequency depends on how many symbol rates the link supports:

The link supports only two symbol rate transmissions: the carrier frequency will be set to the original carrier frequency F₀.

The link supports several symbol rate transmissions. By default the system with the higher symbol rate uses the same carrier frequency F₁ as with the lower symbol rate, if the channel boundaries are not exceeded, i.e., F₂=F₁. If there is a possibility to exceed the channel boundaries after the change, F₂ is as close to F₁ as possible in such a way that the channel boundaries are not exceeded after the change to the new signal bandwidth W₂.

Then by analyzing SNR values, the system will search for the new carrier frequency for the new band W₂ which supports the new symbol rate. The optimization method is same as described above, namely by analyzing EV spectrum or by analyzing SNR values within new bandwidth.

In a still further embodiment, an optional method for estimating interference when changing from lower to higher symbol rate can be provided, where the receiver samples the received signal with the maximum sampling frequency that is independent of the symbol rate. Also the analog anti-alias filtering of the receiver could be independent of the symbol rate.

As can be gathered from the dashed lined blocks 30, 74 and 90 in the left portion of FIG. 1, an additional or optional spectrum calculation block or unit 74 is provided, which can directly receive a complex input signal l+jQ comprising a real part (which corresponds to the input of the LP filter 10-1) and an imaginary part Q (which corresponds to the input of the other LP filter 10-2). Thus, before digital channel filtering, a spectrum (e.g. FFT) is calculated from the received complex signal samples and the interference level outside the wanted or desired signal band can be estimated at the microprocessor (μP) 80. In this way, the channel spectrum outside the transmission bandwidth can be estimated and the interference and/or noise estimate can then be used to see if the interference level is at such a level that the changing from lower to higher symbol rate and/or the selection of another carrier frequency can be done without any decrease in the received signal quality. This procedure or algorithm selects the best RF channel and/or information rate in terms of SINR.

FIG. 5 shows a schematic block diagram of an alternative software-based embodiment of the proposed functionalities for optimization. The required functionalities can be implemented in a receiver or detection module 200 with a processing unit 210, which may be any processor or computer device with a control unit which performs control based on software routines of a control program stored in a memory 212. Program code instructions are fetched from the memory 212 and are loaded to the control unit of the processing unit 210 in order to perform the processing steps of the above functionalities described the flow diagrams of FIGS. 2 to 4. These processing steps may be performed on the basis of input data DI and may generate output data DO, wherein the input data DI may correspond to the samples or symbols obtained from the down-sampling unit 20 of FIG. 1, and the output data DO may correspond to the selected carrier frequency or channel.

In summary, a method, apparatus, and computer program product have been described, wherein an information rate or bandwidth of a transmission signal is controlled in response to a channel condition, and qualities of channels are measured over a transmission bandwidth available for transmission of said transmission signal. A carrier frequency for said transmission signal is selected based on the measured channel qualities.

The present invention is not restricted to the above predetermined embodiments. For example, the present invention may be applied to any communication system which provides an adaptive information rate scheme with different selectable carrier frequencies or channels. The preferred embodiment may thus vary within the scope of the attached claims.

1. A method, comprising:
controlling one of an information rate or a bandwidth of a transmission signal in response to a channel condition;
measuring qualities of channels over a transmission bandwidth available for transmission of said transmission signal; and
selecting a carrier frequency for said transmission signal based on the measured channel qualities.

2. The method according to claim 1, wherein said measuring of qualities of channels comprises determining a spectrum of error vector samples.

3. The method according to claim 2, wherein said determining of said spectrum comprises calculating a fast Fourier transform of said error vector samples.

4. The method according to claim 1, wherein a change to said selected carrier frequency is commanded to a far-end transmitter of said transmission signal at a predetermined timing.

5. The method according to claim 1, wherein said measuring comprises sweeping an actual carrier frequency from a minimum allowed frequency to a maximum allowed frequency, and measuring a signal-to-interference-and-noise level during said sweeping.

6. The method according to claim 1, wherein said measuring comprises switching off transmitters at both transmission ends, sweeping at both transmission ends over said transmission bandwidth, and measuring an interference-and-noise level during said sweeping.

7. The method according to claim 6, wherein said selecting comprises negotiating a transmission channel between said both transmission ends based on said measured interference-and-noise level.

8. The method according to claim 1, wherein said selecting of said carrier frequency is based on a determination of the minimum interference level over said transmission bandwidth.

9. The method according to claim 1, further comprising estimating an interference level outside a desired bandwidth of said transmission signal, and deciding, based on said estimating, on a change of said information rate.

10. The method according to claim 1, wherein said measuring and selection is performed in response to a change of said information rate or bandwidth.

11. The method according to claim 1, further comprising estimating at least one of a noise and interference level outside a desired bandwidth of said transmission signal, and deciding, based on said estimating, on a change of a selected carrier frequency.

12. An apparatus, comprising:
a receiving unit configured to receive a transmission signal with an information rate or bandwidth controlled in response to a channel condition;
a measuring unit configured to measure qualities of channels over a transmission bandwidth available for transmission of said transmission signal; and
a selection unit configured to select a carrier frequency for said transmission signal based on the measured channel qualities.

13. The apparatus according to claim 12, wherein said measuring unit is configured to determine a spectrum of error vector samples.

14. The apparatus according to claim 13, wherein said measuring unit is configured to determine said spectrum by calculating a fast Fourier transform of said error vector samples.

15. The apparatus according to claim 12, wherein said apparatus is configured to command a change to said selected carrier frequency to a far-end transmitter of said transmission signal at a predetermined timing.

16. The apparatus according to claim 12, wherein said measuring unit is configured to sweep an actual carrier frequency from a minimum allowed frequency to a maximum allowed frequency, and to measure a signal-to-interference-and-noise level during said sweeping.

17. The apparatus according to claim 12, wherein said measuring unit is configured to switch off transmitters at both transmission ends, to sweep over said transmission bandwidth, and to measure an interference-and-noise level during said sweeping.

18. The method according to claim 17, wherein said selection unit is configured to negotiate a transmission channel between said both transmission ends based on said measured interference-and-noise level.

19. The apparatus according to claim 12, wherein said selection unit is configured to select said carrier frequency based on a determination of the minimum interference level over said transmission bandwidth.

20. The apparatus according to claim 12, wherein said measuring unit is configured to estimate an interference level outside a desired bandwidth of said transmission signal, and wherein a change of said information rate is decided based on the interference estimation.

21. The apparatus according to claim 12, wherein said measuring and selection units are configured to perform said measuring and selection in response to a change of said information rate or bandwidth.

22. The apparatus according to claim 12, wherein said selection unit is configured to estimate at least one of a noise and interference level outside a desired bandwidth of said transmission signal, and to decide based on said estimation on a change of a selected carrier frequency.

23. An apparatus, comprising:
receiving means for receiving a transmission signal with an information rate controlled in response to a channel condition;
measuring means for measuring qualities of channels over a transmission bandwidth available for transmission of said transmission signal; and
selecting means for selecting a carrier frequency for said transmission signal based on the measured channel qualities.

24. A terminal device, comprising:
a receiving unit configured to receive a transmission signal with an information rate or bandwidth controlled in response to a channel condition;
a measuring unit configured to measure qualities of channels over a transmission bandwidth available for transmission of said transmission signal; and
a selection unit configured to select a carrier frequency for said transmission signal based on the measured channel qualities.

25. A receiver module, comprising:
a receiving unit configured to receive a transmission signal with an information rate or bandwidth controlled in response to a channel condition;
a measuring unit configured to measure qualities of channels over a transmission bandwidth available for transmission of said transmission signal; and
a selection unit configured to select a carrier frequency for said transmission signal based on the measured channel qualities.

26. A transceiver, comprising:
a receiving unit configured to receive a transmission signal with an information rate or bandwidth controlled in response to a channel condition;
a measuring unit configured to measure qualities of channels over a transmission bandwidth available for transmission of said transmission signal; and
a selection unit configured to select a carrier frequency for said transmission signal based on the measured channel qualities.

27. A chip device, comprising:
a receiving unit configured to receive a transmission signal with an information rate or bandwidth controlled in response to a channel condition;
a measuring unit configured to measure qualities of channels over a transmission bandwidth available for transmission of said transmission signal; and
a selection unit configured to select a carrier frequency for said transmission signal based on the measured channel qualities.

28. A computer-readable medium comprising computer code for performing a method when run on a computer device, the method comprising:
controlling one of an information rate or a bandwidth of a transmission signal in response to a channel condition;
measuring qualities of channels over a transmission bandwidth available for transmission of said transmission signal; and
selecting a carrier frequency for said transmission signal based on the measured channel qualities.
